(19) United States
(12) Patent Application Publication
(10) Pub. No.: US 2022/0285884 A1
(43) Pub. Date: Sep. 8, 2022

(54) CONNECTOR WITH CONNECTOR POSITION ASSURANCE

(71) Applicant: J.S.T. Corporation, Farmington Hills, MI (US)

(72) Inventors: Ping CHEN, Novi, MI (US); Kurt HUTCHISON, Novi, MI (US)

(21) Appl. No.: 17/687,306

(22) Filed: Mar. 4, 2022

Related U.S. Application Data
(60) Provisional application No. 63/157,449, filed on Mar. 5, 2021.

(51) Int. Cl. H01R 13/641; H01R 13/627

(52) U.S. Cl. CPC H01R 13/641; H01R 13/6272; H01R 2201/26

(57) ABSTRACT

An electrical connector is provided. The electrical connector can include a female housing and a connector position assurance member forming a pre-installed assembly. A male housing of the electrical connector can receive the assembly. Coupling of the assembly and the male housing can permit movement of the connector position assurance member to a final lock position, thus providing connector position assurance to the electrical connector.

### CROSS-REFERENCE TO RELATED APPLICATIONS

The present application claims benefit of and priority to U.S. Provisional Patent App. No. 63/157,449, filed Mar. 5, 2021, which is incorporated herein by reference in its entirety for all purposes.

### FIELD

The present disclosure relates to connectors. In particular, aspects relate to an electrical connector with connector position assurance.

### BACKGROUND

An electrical connector can be used in various wiring systems, e.g. vehicle wiring. Electrical connectors can include a male housing, a female housing, and a connector position assurance member. The male housing and female housing can be coupled to each other with connector position assurance to resist disconnection and therefore maintain the electrical connection. A connector position assurance member can move to a final lock position to assure coupling of the male housing and female housing, and the electrical connector can move to a fully mated position when the male housing and female housing are coupled. Movement to the final lock position and fully mated position can provide feedback, assuring the coupling of the male housing and a female housing. The connector position assurance member can be released and the connector housings decoupled for electrical connector maintenance.

### BRIEF SUMMARY

An aspect provides a connector having a male housing, a female housing, and a connector position assurance member. The male housing can have a downwardly extending arm. The female housing can have a bridge to engage the downwardly extending arm. The connector position assurance member can have an upwardly extending deflecting arm, which can have an edge to abut the bridge. In an aspect, the female housing can include an aperture to receive the downwardly extending arm. In another aspect, the downwardly extending arm, bridge, and deflecting arm can be generally aligned along a coupling axis. In a further aspect, the downwardly extending arm and the bridge can abut a top of the male housing. In another aspect, during coupling, the bridge can be elastically deformed downward from its initial position. In a further aspect, the downwardly extending arm can be rigid to drive the bridge downward from the initial position during coupling. In a further aspect, prior to coupling, the bridge can be seated in an edge of the connector position assurance member to engage the connector position assurance member and move the connector position assurance member downward during coupling. In another aspect, after coupling, the bridge can return to the initial position. In another aspect, during coupling the downwardly extending arm and the deflecting arm can be aligned in a longitudinal direction.

Another aspect provides an assembly for a connector. The assembly can include a housing and a connector position assurance member. The housing can include a guide structure having an aperture and a bridge. The connector position assurance member can include a center beam disposed in the aperture and an arm to engage with the bridge. In an aspect, the center beam can be cantilevered. In a further aspect, the bridge can be depressed to deflect the center beam when the assembly is coupled to a male housing. In a further aspect, the guide structure can engage with the connector position assurance member to prevent deflection of the center beam. In another aspect, the arm abuts a first side and a second side of the bridge. In another aspect, the arm can extend across one or more sides of the bridge. In a further aspect, the bridge can be positioned in a curved edge of the arm to block the arm from advancing toward a rear of the housing. In a further aspect, the bridge can be positioned in an inclined edge of the arm to retain the arm in the housing.

Another aspect provides a connector position assurance member. The connector position assurance member can include a front wall at a first height; a medial wall extending perpendicularly from the front wall at a second height lower than the first height; a lateral beam at a third height lower than the second height; and a center beam adjacent to the lateral beam. In an aspect, the center beam can include an inclined bottom surface. In another aspect, the lateral beam can include one or more outwardly extending protrusions to engage one or more surfaces of a housing.

Another aspect provides a method of coupling a first housing and a second housing. The method can include advancing a downwardly extending arm of the first housing over a bridge of the second housing to deflect the bridge downward; deflecting a connector position assurance member deflecting arm; positioning the bridge intermediate to the downwardly extending arm and the deflecting arm; and preventing the deflecting arm from deflecting when the bridge is intermediate to the downwardly extending arm and the deflecting arm. In an aspect, the second arm can extend upwardly from a connector position assurance member, which can include one or more medial walls that can extend upwardly from the connector position assurance member beyond the deflecting arm. In another aspect, the second housing can include a guide structure to engage the one or more medial walls to prevent the second arm from deflecting when the bridge is intermediate to the downwardly extending arm and the deflecting arm.

### BRIEF DESCRIPTION OF THE DRAWINGS/FIGURES

The accompanying drawings, which are incorporated herein and form part of the specification, illustrate aspects and, together with the description, further serve to explain the principles of the aspects and to enable a person skilled in the relevant art(s) to make and use the aspects.

FIG. 1A is a perspective view of a connector position assurance member according to various aspects.

FIG. 1B is a top view of the connector position assurance member of FIG. 1A.

FIG. 1C is a side view of the connector position assurance member of FIG. 1A.

FIG. 1D is a perspective view of the connector position assurance member of FIG. 1A.

FIG. 2 is an assembly view of a connector according to various aspects.

FIG. 3 is a perspective view of a female housing according to various aspects.

FIG. 4 is a top view of a female connector housing and a connector position assurance member according to various aspects.

FIG. 5 is a perspective view of the female connector housing and a connector position assurance member of FIG. 4.

FIG. 6 is a top cross-sectional view of the female connector housing and a connector position assurance member of FIG. 5 along line 6-6.

FIG. 7 is a top cross-sectional view of the female connector housing and a connector position assurance member of FIG. 5 along line 7-7.

FIG. 8 is a perspective view of the connector of FIG. 2.

FIG. 9A is a side cross-sectional view of the connector of FIG. 8 along line 9A-9A.

FIG. 9B is a detailed view of FIG. 9A.

FIG. 10 is a detail cross-sectional view of a connector according to various aspects.

FIG. 11 is a detail cross-sectional view of a connector according to various aspects.

FIG. 12 is a detail cross-sectional view of a connector according to various aspects.

FIG. 13 is a perspective view of the connector of FIG. 2.

FIG. 14 is a top cross-sectional view of the connector of FIG. 13 along line 14-14.

FIG. 15 is a side view of the connector of FIG. 2.

FIG. 16 is a side cross-sectional view of the connector of FIG. 13 along line 16-16.

The features and advantages of the aspects will become more apparent from the detail description set forth below when taken in conjunction with the drawings, in which like reference characters identify corresponding elements throughout. In the drawings like reference numbers generally indicate identical, functionally similar, and/or structurally similar elements.

### DETAILED DESCRIPTION

The present invention(s) will now be described in detail with reference to aspects thereof as illustrated in the accompanying drawings. References to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The following examples are illustrative, but not limiting, of the present aspects. Other suitable modifications and adaptations of the variety of conditions and parameters normally encountered in the field, and which would be apparent to those skilled in the art, are within the spirit and scope of the disclosure.

As used herein, the term “approximately” is inclusive of the number to which it refers and includes numbers that bound and are within a range of 5%, 10%, 15%, or 20% except where such number would exceed 100% of a possible value.

Aspects provide an electrical connector for a wiring system, such as a vehicle wiring system. The electrical connector described herein can have improved connector position assurance. The electrical connector can include a female housing, a male housing, and a connector position assurance member (“CPA member”). The female housing and the CPA member can form an assembly that can be coupled to the male housing with position assurance. Position assurance is important in wiring systems to ensure and maintain terminal mating and resist disconnection. To ensure coupling, a higher force can be required to couple the assembly with the male housing. The coupling can be intentionally released for maintenance by overcoming the resistance to disconnection. The CPA member can be released to allow decoupling of the female housing and male housing. Advantageously, feedback (e.g., a visual, tactile, and/or auditory feedback) can be provided to signal that the connector housings are coupled with position assurance. The CPA member described herein can additionally have a low profile to limit the size of the electrical connector. The coupling with connector position assurance between the assembly and the male housing can move the electrical connector from a pre-mate position to a fully mated position.

The female housing can include a top having grooves for receiving the CPA member. The CPA member can have one or more lateral beams that can be received by the grooves of the female housing. As described herein, the lateral beams can include one or more protrusions that extend outwardly to fill the clearance between the lateral beams and the grooves of the female housing. As such, the protrusions of the CPA member can tightly fit the CPA member into the grooves of the female housing. The fit can provide anti-buzz, squeak, and rattle (BSR) effects from the electrical connector when installed in a vehicle, for example. BSR effects, such as rattling, can be undesirable. The CPA member described herein can include the protrusions along sides of its lateral beams. The fit between the CPA member and the female housing can limit relative motion between the CPA member and the female housing to reduce or eliminate BSR effects. The fit can also support connector position assurance by maintaining a strong coupling between the female housing and the CPA member.

The assembly including the female housing and the CPA member can be pre-installed. Accordingly, a user does not have to couple the CPA member to the female housing. To support connector position assurance when coupling the assembly to the male housing, the assembly can be prevented from being taken apart. In this way, the CPA member can be prevented from being decoupled from the female housing which can damage the assembly. The grooves of the female housing can include one or more retention detents that fit with one or more cutouts on the lateral beams of the CPA member to retain the CPA member and prevent decoupling of the assembly.

The CPA member can include a center beam that can deflect to move from a pre-lock position to a final lock position such that the electrical connector can move from the pre-mate position to the fully mated position. In the pre-lock position, a deflecting arm that can extend upward from a top surface of the CPA member center beam can be aligned with a flexible bridge of the female housing along a transverse axis generally parallel to the top surface of the CPA member center beam. As described herein, the upward direction can be a longitudinal direction generally parallel to a longitudinal axis. The bridge can abut and engage with an edge of the CPA member in this position. The bridge does not cause the center beam of the CPA member to deflect in this position. Instead, the bridge and CPA member are in blocking engagement such that the CPA member does not deflect and cannot advance generally along a flat plane toward the rear of the female housing. Accordingly, the bridge does not initiate advancement of the CPA member to the final lock position.

A deflecting arm that can extend downward from a top of the male housing can initiate advancement of the CPA member to the final lock position. As described herein, the downward direction can be a longitudinal direction generally parallel to a longitudinal axis. In the pre-lock position, the lock arm of the male housing can abut and engage with the flexible bridge. In an aspect, the lock arm can be aligned with the flexible bridge of the female housing along a transverse axis generally parallel to the top of the male housing. The assembly of the female housing and the CPA member can be advanced toward a rear of the male housing, causing the lock arm of the male housing and the flexible bridge to move out of the transverse alignment. As the assembly is advanced, the lock arm of the male housing can depress the flexible bridge away from its initial position. The lock arm of the male housing, applying a load generally perpendicular to a transverse axis of the flexible bridge, can depress the flexible bridge such that the components can move into alignment along a longitudinal axis generally perpendicular to the top of the male housing. Continuing to advance the assembly can cause the lock arm of the male housing and the flexible bridge to move out of longitudinal alignment. The flexible bridge can then move upwards to its initial position where it can once again be aligned with the lock arm of the male housing along a transverse axis generally parallel to the top of the male housing. The flexible bridge can contact the top of the male housing when returning to its initial position, which can create a tactile and/or audible feedback signal (e.g., a click sound). In this position, the flexible bridge no longer abuts and engages with the deflecting arm of the CPA member.

Advancing the assembly can cause the center beam of the CPA member, which can be elastically deformed, to deflect. As the flexible bridge is depressed, the flexible bridge can apply a load generally perpendicular to a transverse axis of the CPA member center beam to deflect the center beam in a downward direction away from its undeformed state. As the flexible bridge moves out of alignment with the deflecting arm of the CPA member along a transverse axis generally parallel to the top surface of the CPA member center beam, the components are no longer in blocking engagement. Instead, the CPA member can advance generally along a flat plane toward the rear of the female housing with the center beam deflecting away from its undeformed state along the flat plane. The CPA member deflecting arm, aided by the center beam bias toward its undeformed state along the flat plane, can move over generally curved edges of the lock arm of the male housing and the flexible bridge. The CPA member can continue to advance toward the rear of the female housing until its deflecting arm can abut and engage with the flexible bridge. In an aspect, the CPA member can be aligned with the flexible bridge along a transverse axis generally parallel to the top surface of the CPA member center beam once again. Once the deflecting arm of the CPA member reaches this position, the CPA member is in the final lock position, and the electrical connector is in the fully mated position (e.g., the female housing and the male housing are coupled and fully mated).

Similar to the flexible bridge, in the final lock position, the deflecting arm of the CPA member can abut and engage with the top of the male housing. The contact between the top of the male housing and the deflecting arm of the CPA member when returning to its undeformed state can additionally create a tactile and/or audible feedback signal (e.g., a click sound) signaling that the connector housings are in the fully mated position and coupled with position assurance. Visual feedback can also be provided as the front wall of the CPA member can abut and engage with the front of the female housing. Contact between a rear of the male housing and the rear of the female housing can prevent the male housing from advancing further once the fully mated position is achieved.

The CPA member cannot be advanced into the final lock position unless the male housing is present. For example, the pre-installed assembly of the female housing and the CPA member does not allow for deflection of the CPA member center beam. Instead, the CPA member is in blocking engagement with the bridge of the female housing such that the CPA member cannot advance generally along a flat plane toward the rear of the female housing. This can prevent unintended deflection of the CPA member center beam.

It is desirable when the male housing and female housing are coupled in the fully mated position to have a high resistance to decoupling. High resistance to decoupling is desirable to prevent the male housing and female housing from returning to the pre-mate position. As such, decoupling from the fully mated position can require overcoming a specified resistance that is greater than the resistance to coupling to the fully mated position. Further, the female housing can include a guide structure having an upper wall and sidewalls. An aperture through which the CPA member can be inserted to form the assembly can be bound by the upper wall and sidewalls of the guide structure. In the pre-lock position, the CPA member center beam can deflect downwardly in order to advance to the final lock position. In the final lock position, one or more medial walls of the CPA member can abut and engage with the upper wall of the female housing guide structure. In an aspect, the CPA member can align with the upper wall of the female housing guide structure along a longitudinal axis generally perpendicular to the top surface of the CPA member center beam. The fit between the guide structure and the CPA member can prevent further deflection of the CPA member center beam to support the resistance to decoupling from the fully mated position. Overcoming this resistance can be difficult in order to prevent accidental decoupling, but can be done intentionally to provide maintenance to the electrical connector, for example. The CPA member can be released to allow decoupling of the female housing and male housing.

The pre-installed assembly of the female housing and the CPA member can help to prevent components from being detached and/or misplaced. As described herein, retention detents of the female housing can fit with one or more cutouts on the lateral beams of the CPA member to retain the CPA member and prevent decoupling of the assembly. In addition, movement of the CPA member to advance from the pre-lock position to the lock position (e.g., deflection of the center beam) can be contained at least partially within the female housing, which can reduce the overall size of the electrical connector. This is beneficial in vehicle wiring systems, for example, that are complex and require numerous components with high reliability, but space is limited. In some aspects, the grooves that receive the CPA member can at least partially contain the movement of the CPA member. Limiting movement of the CPA member to be contained at least partially within the female housing can also limit the overall size of the electrical connector. By containing the center beam deflection movement, for example, connector size in a longitudinal direction can be reduced. The CPA member can additionally include one or more gaps to receive the female housing guide structure sidewalls, which can deflect downwardly when the bridge is depressed. Receiving the guide structure sidewalls in the CPA member gaps can reduce connector size in a longitudinal direction as well.

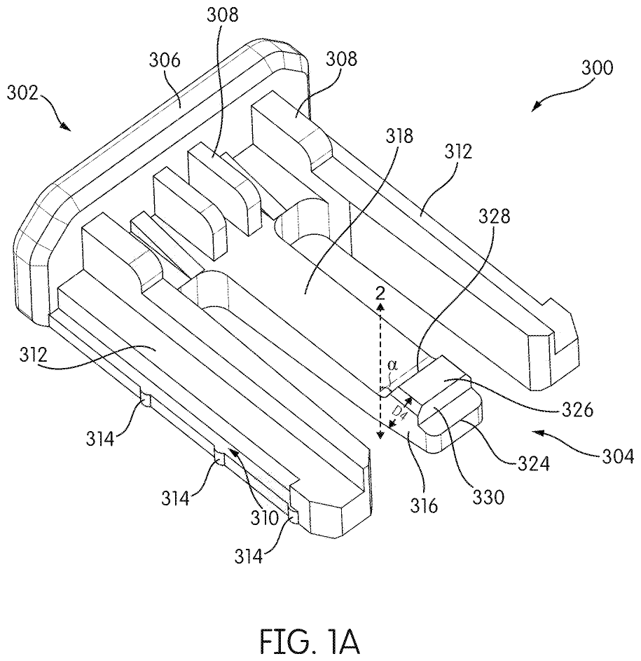

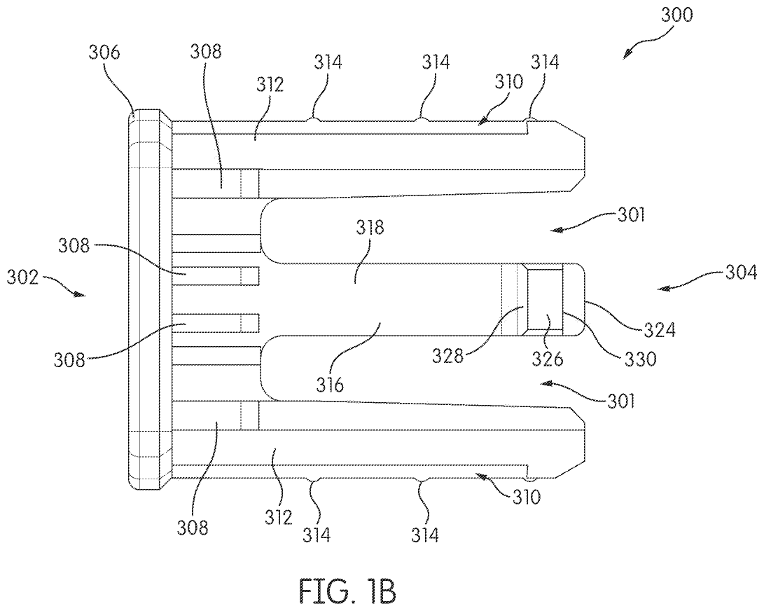

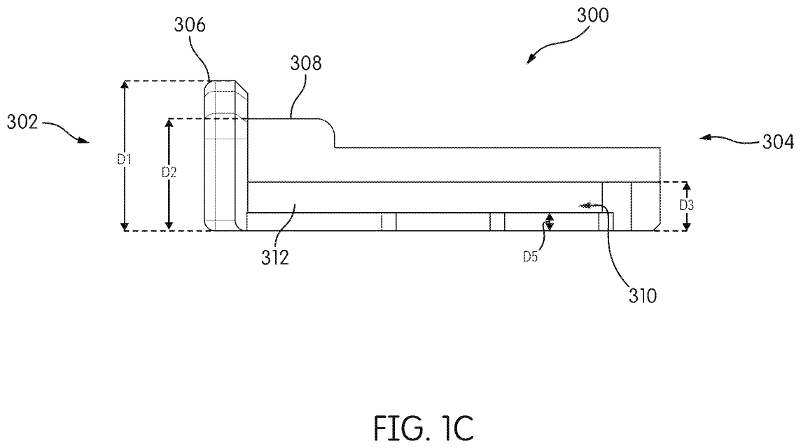

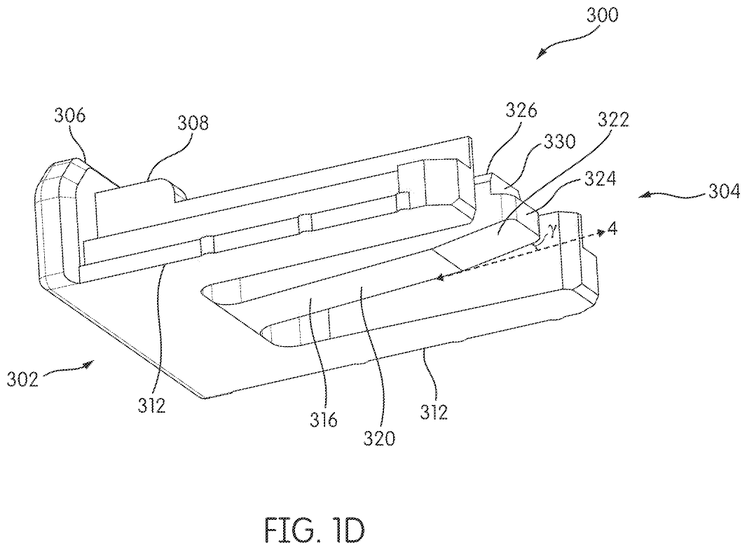

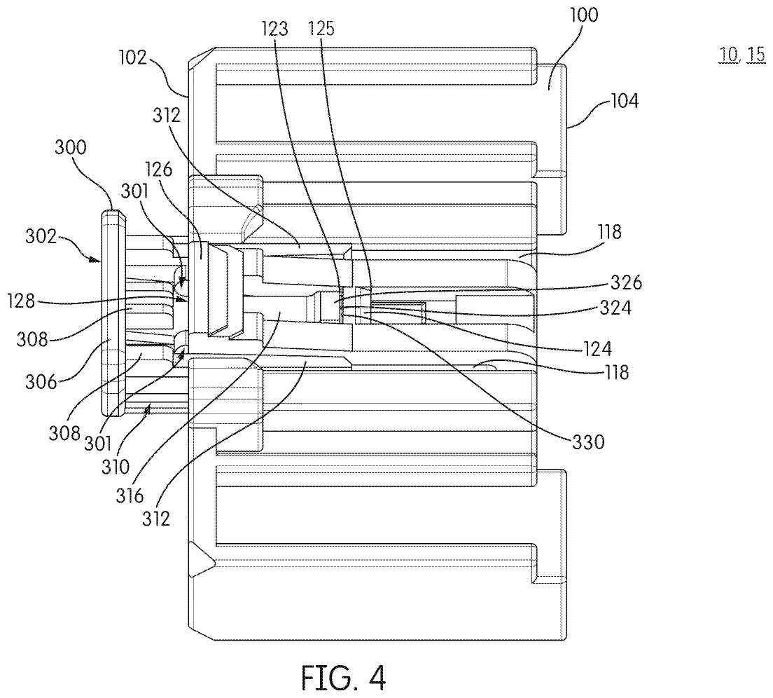

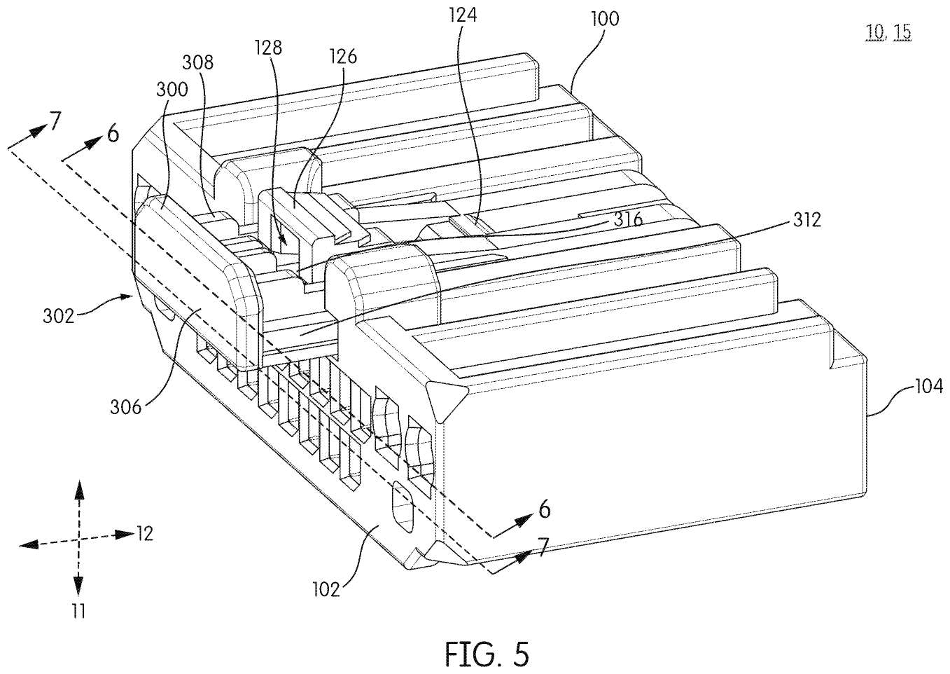

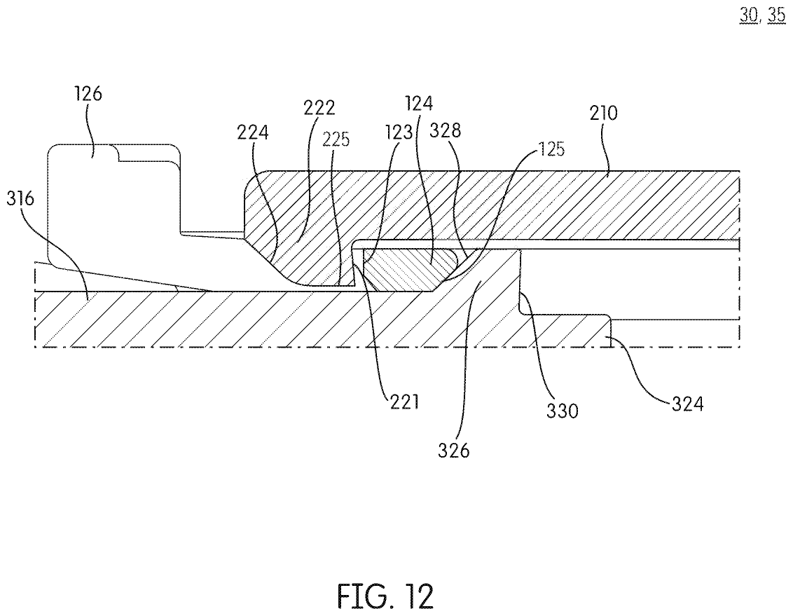

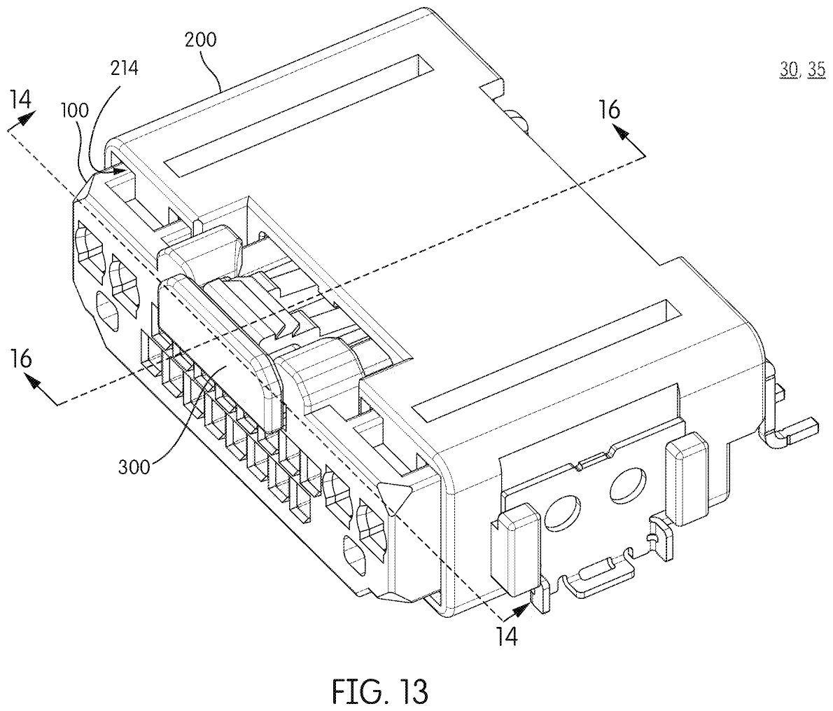

A CPA member 300 is shown in FIGS. 1A-D. CPA member 300 can move from a pre-lock position 15 (FIGS. 4-5) to a final lock position 35 (FIGS. 12-13). CPA member 300 can include a front 302, a rear 304, a front wall 306, one or more medial walls 308, one or more cutouts 310, one or more lateral beams 312, one or more anti-BSR protrusions 314, a center beam 316, and one or more gaps 301. Center beam 316 can include a top surface 318 and a bottom surface 320. Bottom surface 320 can include an inclined edge 322. Center beam 316 can additionally include a lock tip 324 and a deflecting arm 326 having a trailing edge 328 and a leading edge 330.

In some aspects, the front-most portion of CPA member 300 can be front wall 306. Front wall 306 can reach a first height, D1 (FIG. 1C), that is taller than a second height, D2 (FIG. 1C), of medial walls 308. Medial walls 308 can extend generally perpendicularly from front wall 306 toward rear 304. In some aspects, lateral beams 312 can reach a third height, D3 (FIG. 1C), and center beam 316 can reach a fourth height, D4 (FIG. 1A), where D3 and D4 are both shorter than the first height, D1, of front wall 306 and the second height, D2, of medial walls 308.

In some aspects, as shown in FIG. 1C, portions of lateral beams 312 can reach a fifth height, D5. In an aspect, anti-BSR protrusions 314 can extend outwardly from lateral beams 312 and reach the fifth height, D5, which can be shorter than the third height, D3. Accordingly, lateral beams 312 can include portions at both the third height, D3, and the fifth height, D5. In an aspect, the portion of each lateral beam 312 that reaches the fifth height, D5, can form a lower level of lateral beam 312. In an aspect, the portion of each lateral beam 312 that reaches the third height, D3, can form an upper level of lateral beam 312

As shown in FIG. 1B, in some aspects, lateral beams 312 can include cutouts 310 that can extend in a transverse direction generally parallel to transverse axis 12 (FIG. 5) from lateral beams 312 at front 302 of CPA member 300 to a portion of lateral beams 312 between front 302 and rear 304 of CPA member 300. Accordingly, cutouts 310 can extend partially through lateral beams 312. With reference to FIG. 1C, in an aspect, cutouts 310 can extend through lateral beams 312 between the third height, D3 and the fifth height, D5. Accordingly, a cutout 310 can be formed between the lower level and the upper level of each lateral beam 312. In an aspect, the portion of lateral beams 312 toward rear 304 of CPA member 300 through which cutouts 310 do not extend can be at the third height, D3. Thus, the portion of each lateral beam 312 that reaches the shorter fifth height, D5, can coincide with the portion of lateral beam that reaches the third height, D3.

In some aspects, lateral beams 312 and center beam 316 can extend toward rear 304. In an aspect, center beam 316 can be cantilevered such that it can deflect, with lock tip 324 being the free end. Deflecting arm 326 can be positioned on lock tip 324 and can extend upwardly in a longitudinal direction generally parallel to longitudinal axis 11 (FIG. 5) from top surface 318. In an aspect, trailing edge 328 can be an abutment edge that can be generally inclined. In another aspect, leading edge 330 can be a retention edge having a generally round interior corner. In an aspect, lateral beams 312 and center beam 316 can be separated by gaps 301 (FIG. 1B).

As shown in FIG. 1A, in an aspect, the incline of trailing edge 328 can be at an angle, α, from an axis 2 that can be generally perpendicular to top surface 318. In some aspects, the angle, α, can range from approximately 5 degrees to approximately 60 degrees, such as approximately 15 degrees to approximately 45 degrees, such as approximately 30 degrees. As shown in FIG. 1D, in an aspect, the incline of inclined edge 322 can be at an angle, γ, from an axis 4 that can be generally parallel to bottom surface 320. In some aspects, the angle, γ, can range from approximately 5 degrees to approximately 60 degrees, such as approximately 15 degrees to approximately 45 degrees, such as approximately 30 degrees.

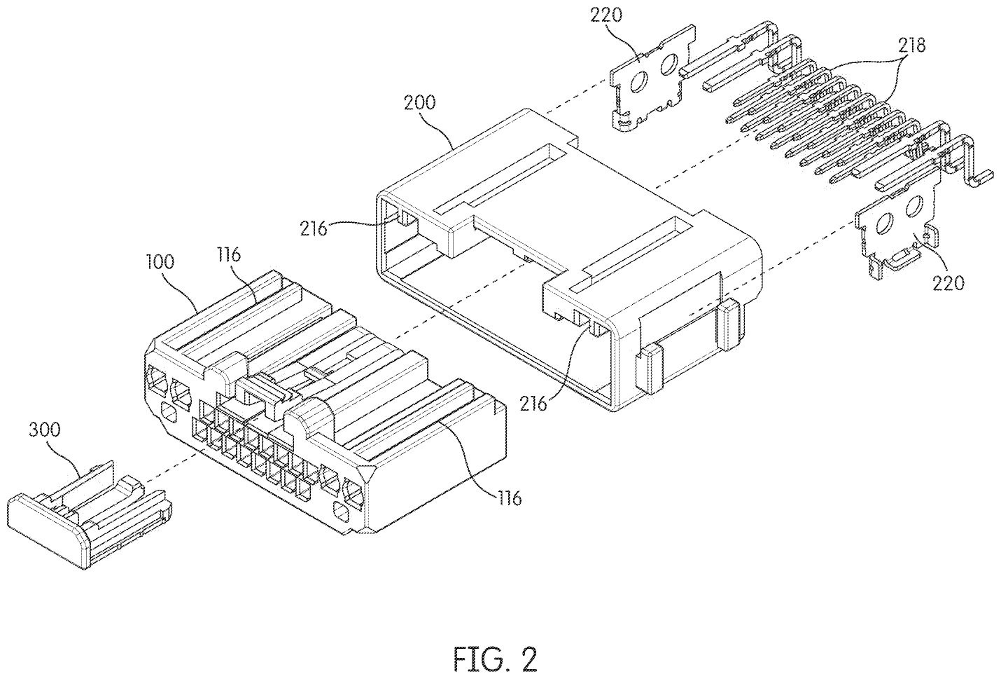

As shown in FIG. 2, an electrical connector can include CPA member 300, female housing 100, and male housing 200. The electrical connector can move from a pre-mate position 10 (FIGS. 4-5) to a fully mated position 30 (FIG. 12-13) as CPA member 300 moves from pre-lock position 15 to final lock position 35. In some aspects, the components can be injection molded plastic. Male housing 200 can support reinforcement tabs 220 and male pins 218. Male housing 200 can receive a pre-installed assembly of female housing 100 and CPA member 300.

CPA member 300 and female housing 100 can be coupled to form the pre-installed assembly. CPA member 300 can be inserted into female housing 100 by rear 304 (FIGS. 1A-D). This assembly can be coupled to male housing 200 to form the electrical connector. Female housing 100 can include one or more key grooves 116 that can receive one or more tracks 216 of male housing 200 that correspond to key grooves 116. Key grooves 116 and tracks 216 can form a keying function so that a certain female housing 100 can only be coupled to a male housing 200 with suitable corresponding tracks 216. In another aspect, female housing 100 and male housing 200 can include differently shaped key grooves 116 and tracks 216, respectively, that correspond to each other.

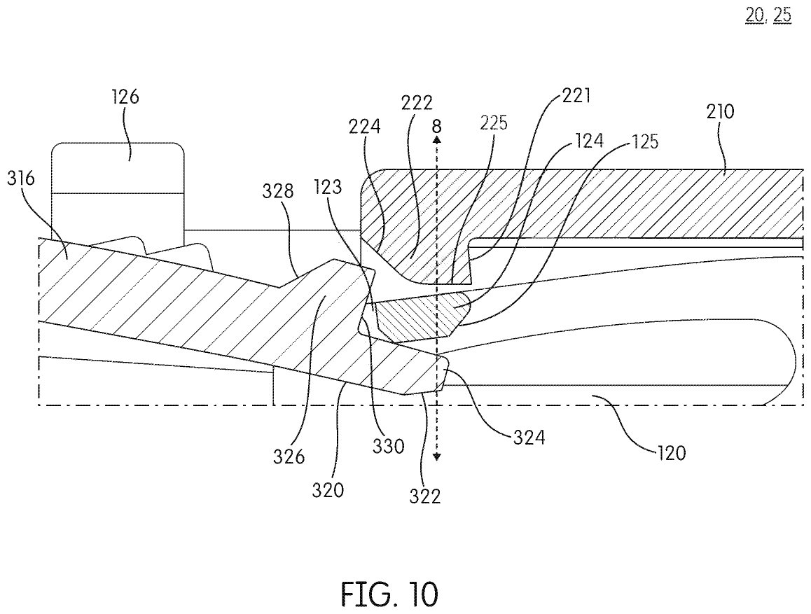

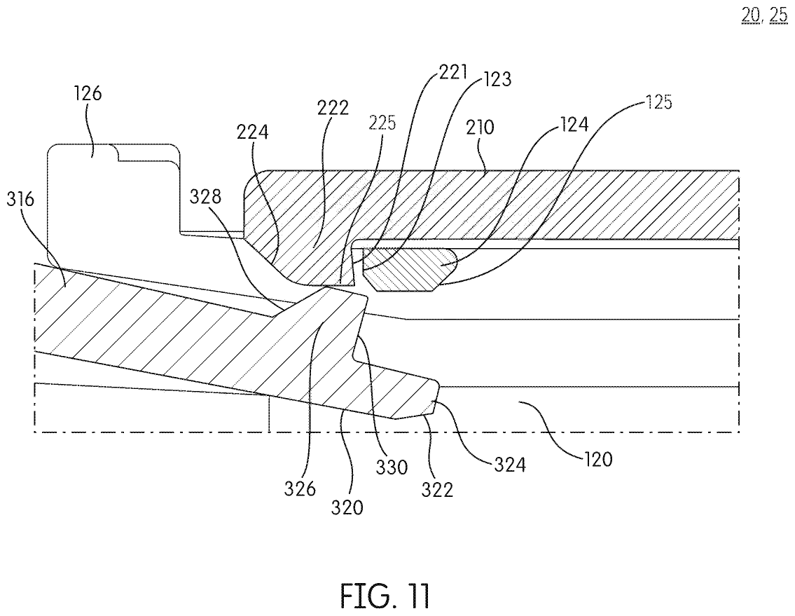

The assembly of female housing 100 and CPA member 300 can advance generally along a flat plane toward male housing 200 to form the electrical connector. As shown in FIGS. 4-5, CPA member 300 can be in a pre-lock position 15 prior to coupling of female housing 100 and male housing 200. Accordingly, the electrical connector can be in pre-mate position 10. As the pre-installed assembly and male housing 200 are being coupled to each other, CPA member 300 and the electrical connector can be in a half-lock position 25 and a half-mate position 20 (FIGS. 10-11), respectively. CPA member 300 can provide connector position assurance for the coupling of female housing 100 and male housing 200 to prevent unintentional decoupling. Female housing 100 coupled with male housing 200 with connector position assurance can be in fully mated position 30 (FIG. 13).

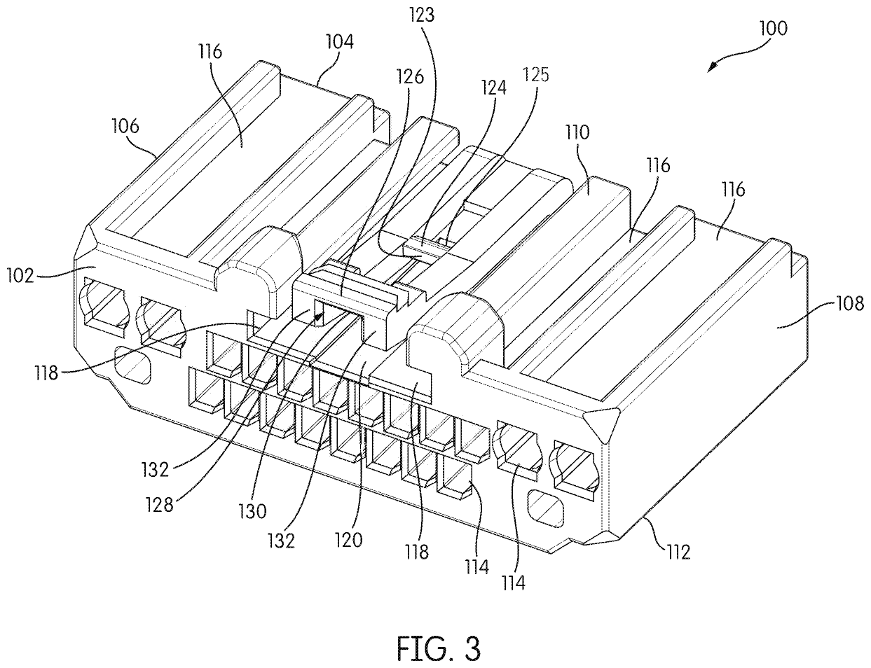

As shown in FIG. 3, female housing 100 can additionally include a front 102, a rear 104, a first side 106, a second side 108, a top 110, a bottom 112, one or more terminal apertures 114, one or more lateral beam grooves 118, center beam groove 120, one or more retention detents 122, a bridge 124 having a leading edge 123 and a trailing edge 125, and a guide structure 126 having an aperture 128, upper wall 130, and sidewalls 132. Terminal aperture 114 can receive a terminal (not shown). In an aspect, bridge 124 can be operatively connected to guide structure 126. In another aspect, bridge 124 and sidewalls 132 of guide structure can be flexible such that they can be elastically deformed downward in a transverse direction generally parallel to transverse axis 12 (FIG. 5) to accommodate the male housing 200. In an aspect, bridge 124 and sidewalls 132 can move together, e.g., moving bridge 124 moves sidewalls 132 and vice versa.

As shown in FIG. 4, pre-installing the assembly of female housing 100 and CPA member 300 can include inserting CPA member 300 into front 102 of female housing 100 by rear 304 of CPA member 300. CPA member 300 can advance generally along a flat plane toward rear 104 of female housing 100 for installation. As such, pre-lock position 15 can include CPA member 300 partially disposed in female housing 100 such that female housing 100 and CPA member 300 are coupled. In an aspect, CPA member 300 can be received in female housing 100 such that the overall profile of the electrical connector is minimized. In an aspect, front 302 of CPA member 300 can extend outwardly from female housing 100 in pre-lock position 15 and pre-mate position 10. Lateral beam grooves 118 of female housing 100 can receive lateral beams 312 of CPA member 300. Center beam groove 120 of female housing 100 can receive center beam 316 of CPA member 300. In pre-lock position 15 and pre-mate position 10, front wall 306 of CPA member 300 can be spaced from front 102 of female housing 100 such that a portion each lateral beam 312 and center beams 316 extends outwardly from female housing 100. This spacing and outward protrusion can provide visual feedback that CPA member 300 is not in final lock position 35, in which front wall 306 of CPA member 300 is proximate to front 102 of female housing 100. Accordingly, the electrical connector cannot be in fully mated position 30 (FIG. 13). In an aspect, front wall 306 of CPA member 300 can be the portion of front 302 that extends outwardly from female housing 100 in final lock position 35 (FIGS. 12-13), indicating that the electrical connector is in fully mated position 30 (FIGS. 12-13).

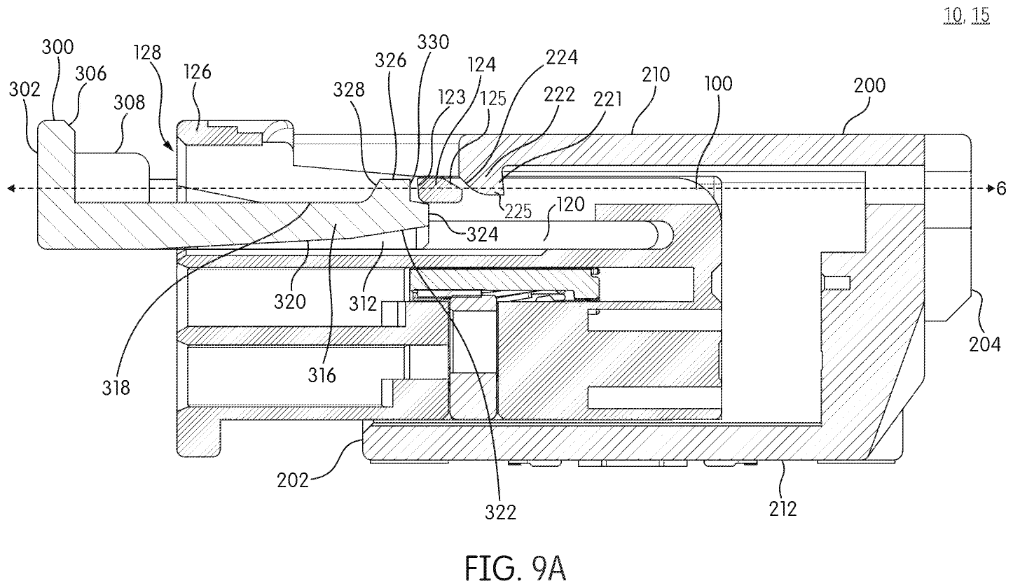

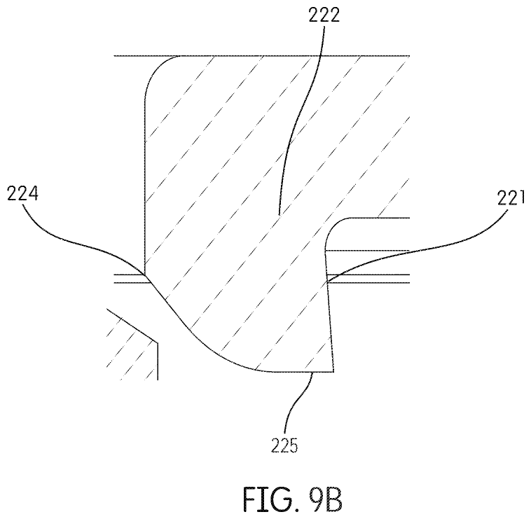

In pre-lock position 15, CPA member 300 can be prevented from advancing further toward rear 104 of female housing 100 by a blocking engagement between deflecting arm 326 of CPA member 300 and bridge 124. In an aspect, deflecting arm 326 can be aligned with bridge 124 along a transverse axis 6 (FIG. 9A) generally parallel to top surface 318 of center beam 316. Leading edge 123 of bridge 124 can be proximate to leading edge 330 of deflecting arm 326 in this position. In an aspect, leading edge 123 of bridge 124 can include a curved shape to align with the generally round interior corner of leading edge 330. Accordingly, leading edge 330 can generally extend around one or more sides of bridge 124 such that bridge 124 can be seated in leading edge 330 of deflecting arm 326. In this position, bridge 124 can retain CPA member 300 and prevent CPA member 300 from advancing such that bridge 124 and CPA member 300 are in a blocking engagement. In the blocking engagement, bridge 124 does not cause center beam 316 of CPA member 300 to deflect to move to final lock position 35. In an aspect, CPA member 300 must deflect downward based on interaction with the male housing in order to move to final lock position 35 (FIG. 12).

As shown in FIG. 2, center beam 316 can be inserted through aperture 128 of guide structure 126. FIG. 5 shows CPA member 300 coupled to female housing 100 in pre-lock position 15 and pre-mate position 10 with center beam 316 disposed in female housing 100 through aperture 128 of guide structure 126. Sidewalls 132 of guide structure 126 can abut and engage with center beam 316 of CPA member 300. Center beam 316 does not abut and engage with upper wall 130 of guide structure 126 in pre-lock position 15 and pre-mate position 10 such that a gap can exist between center beam 316 and upper wall 130, as shown in FIG. 5.

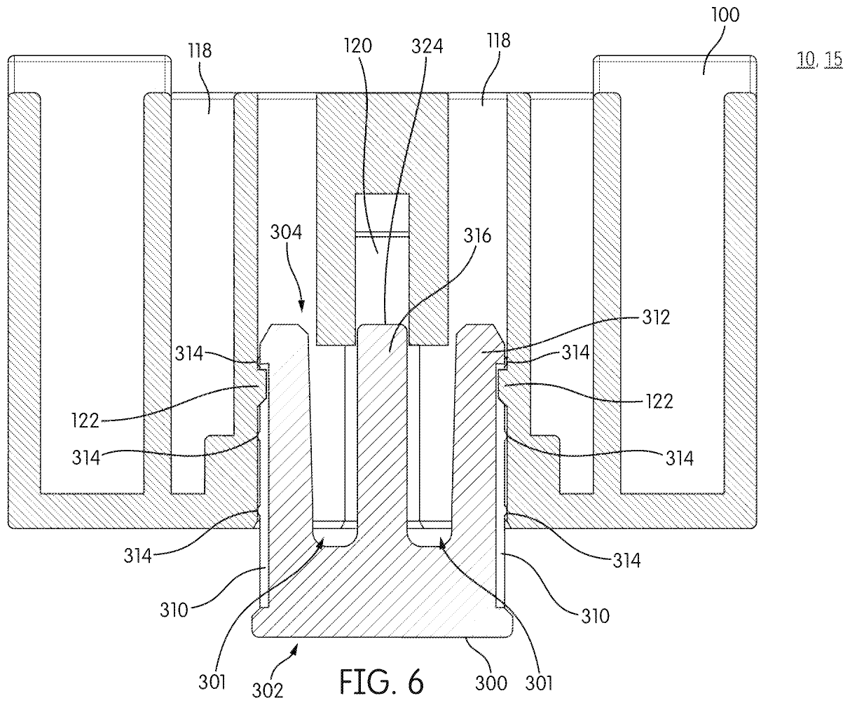

With reference to FIGS. 5-6, retention detents 122 can extend outwardly from female housing 100 into lateral beam grooves 118. Retention detents 122 can engage lateral beams 312 of CPA member 300 and prevent removal of CPA member 300 after CPA member 300 is inserted into the female housing 100 to form the pre-installed assembly. As such, retention detents 122 and CPA member 300 can be in blocking engagement. In some aspects, cutouts 310 of lateral beams 312 can receive retention detents 122. The fit can retain lateral beams 312 in lateral beam grooves 118.

As discussed above, in some aspects, lateral beams 312 can include cutouts 310 that can extend in a transverse direction generally parallel to transverse axis 12 (FIG. 5) from lateral beams 312 at front 302 of CPA member 300 to a portion of lateral beams 312 between front 302 and rear 304 of CPA member 300. Accordingly, cutouts 310 can extend partially through lateral beams 312. In an aspect, the portion of lateral beams 312 toward rear 304 of CPA member 300 through which cutouts 310 do not extend can be at the third height, D3, which can form the upper level of lateral beams 312. In an aspect, cutouts 310 can extend through lateral beams 312 between the third height, D3 and the shorter fifth height, D5. As such, retention detents 122 can extend outwardly and engage with cutouts 310 between the third height, D3 and the fifth height, D5. Because retention detents 122 are rigid, they can engage the portion of lateral beams 312 toward rear 304 of CPA member 300 through which cutouts 310 do not extend and that are at the third height, D3. Accordingly, lateral beams 312 at rear 304 can extend upward in a longitudinal direction generally parallel to longitudinal axis 11 (FIG. 5) to a height generally on the same flat plane as retention detents 122. In this way, lateral beams 312 can engage retention detents 122 such that CPA member 300 is retained in a transverse direction generally parallel to transverse axis 12.

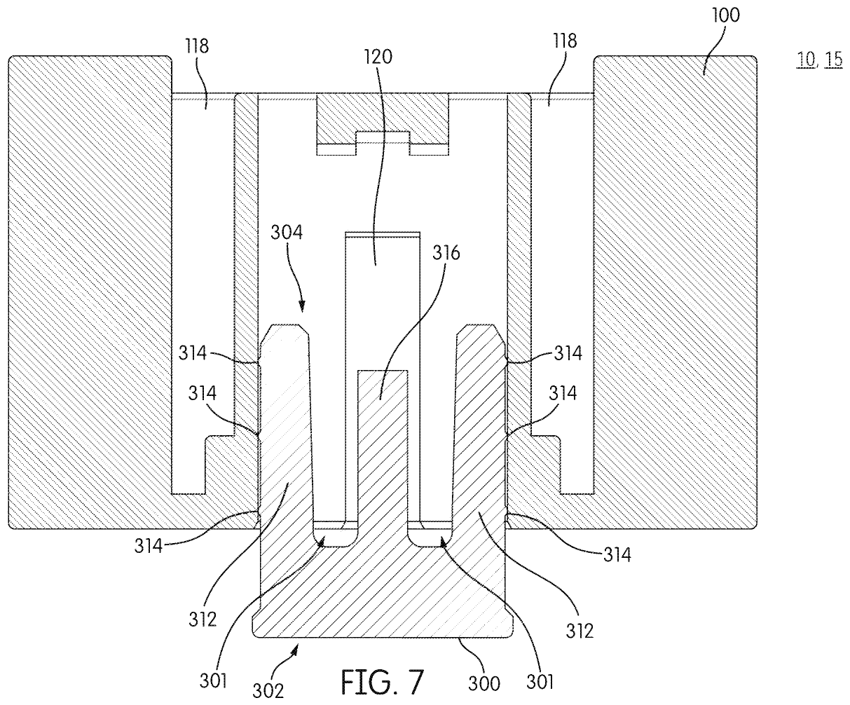

With reference to FIGS. 5-7, in some aspects, retention detents 122 can engage with lateral beams 312 within cutouts 310. As discussed above, with reference to FIG. 1C, in some aspects, cutouts 310 can extend through lateral beams 312 between the lower level of lateral beams 312 at the fifth height, D5, and the upper level of lateral beams 312 at the third height, D3. With reference to FIG. 6, in some aspects, retention detents 122 can extend outwardly from female housing 100 to engage with lateral beams 312 within cutouts 310. FIG. 7 shows a cross-sectional view of the female housing 100 and CPA member 300 assembly in FIG. 5. The cross-sectional view in FIG. 7 is cut at a lower longitudinal position with respect to longitudinal axis 11 (FIG. 5) than the cross-sectional view in FIG. 6 of the assembly. As shown in FIG. 7 and as discussed above, anti-BSR protrusions 314 can extend outwardly from lateral beams 312 at the lower level of lateral beams 312. Retention detents 122 are not visible in FIG. 7 because retentions detents 122 engage with lateral beams 312 within cutouts 310, which do not extend into the lower level of lateral beams 312. As shown in FIG. 7, lateral beams 312 and anti-BSR protrusions 314 can extend into this space to be positioned below retention detents 122 (FIG. 6). Accordingly, in some aspects, retention detents 122 extend over the lower level of lateral beams 312 and female housing 100 can extend around three or more sides of lateral beams 312. In this way, in some aspects, CPA member 300 can be in blocking engagement with retention detents 122 in a longitudinal direction generally parallel to longitudinal axis 11 (FIG. 5) such that CPA member 300 can be retained longitudinally.

With reference to FIGS. 5-7, in some aspects, anti-BSR protrusions 314 can extend outwardly from lateral beams 312 into lateral beam grooves 118 of female housing 100. Anti-BSR protrusions can be positioned below retention detents 122 (FIG. 6) in lateral beam grooves 118. Anti-BSR protrusions 314 can bridge the clearance between lateral beams 312 and female housing 100 to tightly fit and retain lateral beams 312 into lateral beam grooves 118. The fit can provide anti-BSR effects from the electrical connector when installed in a vehicle, for example, by limiting relative motion between CPA member 300 and female housing 100, even at the upper and lower tolerance limits. The fit between anti-BSR protrusions 314 and female housing 100 and between retention detents 122 and CPA member 300 can support connector position assurance by maintaining a strong coupling between the female housing 100 and CPA member 300 assembly.

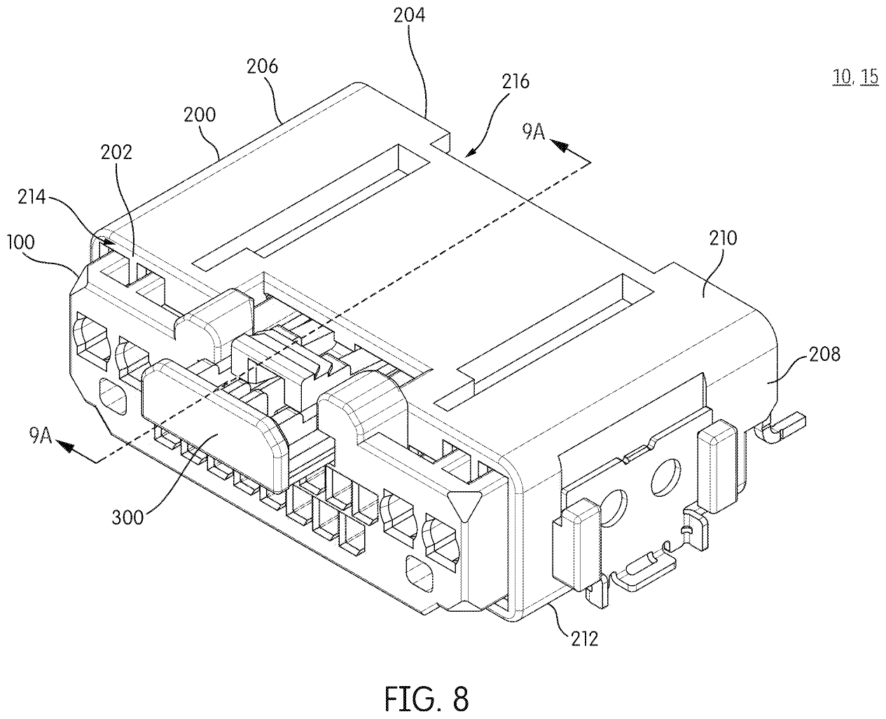

As shown in FIGS. 8-9A, in pre-lock position 15 and pre-mate position 10, deflecting arm 326 can extend upward in a longitudinal direction generally parallel to longitudinal axis 11 (FIG. 5) from center beam 316 of CPA member 300 and can be transversally aligned with bridge 124 of female housing 100 along a transverse axis 6 (FIG. 9A). Transverse axis 6 can be generally parallel to top surface 318 of center beam 316. Leading edge 123 of bridge 124 can abut and engage with leading edge 330 of deflecting arm 326 in this position. In an aspect, leading edge 123 of bridge 124 can be curved to mate with a generally curved interior corner of leading edge 330 for retention. Center beam 316 can deflect downward from its pre-installed position to move the electrical connector from pre-mate position 10 to fully mated position 30 (FIGS. 12-13). In pre-lock position 15 and pre-mate position 10, bridge 124 does not cause center beam 316 to deflect. Instead, bridge 124 and CPA member 300 are in blocking engagement because leading edge 123 of bridge 124 can abut and engage with leading edge 330 of deflecting arm 326. Accordingly, bridge 124 does not initiate advancement of CPA member 300 to final lock position 35 (FIGS. 12-13).

Male housing 200 can additionally include a front 202, a rear 204, a first side 206, a second side 208, a top 210, a bottom 212, and an aperture 214. A lock arm 222 can extend downwardly from top 210 in a longitudinal direction generally parallel to longitudinal axis 11 (FIG. 5). Lock arm 222 can include a leading edge 224 having a bottom edge 225, and a trailing edge 221. With reference to FIGS. 9A-B, in an aspect, leading edge 224 can be angled and/or curved for engagement with bridge 124. In an aspect, bottom edge 225 of leading edge 224 can be flat to engage bridge 124 and deflecting arm 326 of CPA member 300 and deflect the components downward. In an aspect, trailing edge 221 can also be flat to support retaining bridge 124 in final lock position 35 (FIGS. 12-13).

As shown in FIGS. 8-9A, in an aspect, male housing 200 can receive the female housing 100 and CPA member 300 assembly when CPA member 300 is in pre-lock position 15. Aperture 214 can receive the assembly of female housing 100 and CPA member 300. The assembly with the male housing shown in FIGS. 8-9A can be in pre-mate position 10. Lock arm 222 can cause center beam 316 to deflect downward and initiate advancement of CPA member 300 to final lock position 35 (FIG. 13). As shown in FIG. 9A, in pre-lock position 15 and pre-mate position 10, lock arm 222 can be transversally aligned with bridge 124 of female housing 100 along transverse axis 6 (FIG. 9A). Transverse axis 6 can be generally parallel to top 210 of male housing 200 and top surface 318 of CPA member 300.

In an aspect, trailing edge 125 of bridge 124 can be curved and/or inclined to abut and engage with leading edge 224 of lock arm 222, which can include a corresponding curvature/incline. The curvature/incline of leading edge 224 can mate with trailing edge 125 of bridge 124 to support moving bridge 124 downward away from its initial position. As the curvature/incline of leading edge 224 engages the curvature/incline of trailing edge 125 of bridge 124, lock arm 222 and bridge 124 can glide along each other. The flat bottom edge 225 of leading edge 224 can then maintain bridge 124 in its downward position.

FIGS. 10-12 show detail views of the cross-sectional view in FIG. 9A. As shown in FIGS. 10-12, CPA member 300 can advance from pre-lock position 15 (FIGS. 4-5) to final lock position 35 (FIGS. 12-13) such that the electrical connector can be in fully mated position 30 (FIGS. 12-13). With reference to FIG. 10, female housing 100 can be advanced generally along a flat plane toward rear 204 of male housing 200. Accordingly, the assembly of female housing 100 and CPA member 300 and male housing 200 can be coupled to move CPA member inward from pre-lock position 15 to final lock position 35 (FIGS. 12-13).

As shown in FIG. 10, advancing female housing 100 and CPA member 300 with respect to male housing 200 can cause lock arm 222 of male housing 200 and bridge 124 to move downward along longitudinal axis 8 because, in an aspect, bridge 124 can be elastically deformed downward along longitudinal axis 8. In this position, CPA member 300 can be in half-lock position 25, and the electrical connector is in half-mate position 20. As the components are advanced, lock arm 222 of male housing 200 can depress bridge 124 downward from its initial position. In an aspect, leading edge 224 of lock arm 222 can be rigid and generally curved to engage and depress bridge 124. Lock arm 222 of male housing 200 can apply a load along longitudinal axis 8, generally perpendicular to transverse axis 6 (FIG. 9A) in a downward direction. Lock arm 222 can depress bridge 124. The curvature/incline of leading edge 224 can support moving bridge 124 downward away from its initial position. Trailing edge 125 of bridge 124 can include a curvature/incline that engages with the curvature/incline of leading edge 224. Accordingly, lock arm 222 and bridge 124 can glide along each other. As lock arm 222 and bridge 124 glide along each other, the components can move into longitudinal alignment along longitudinal axis 8, generally perpendicular to top 210 of male housing 200. The flat bottom edge 225 of leading edge 224 can then maintain bridge 124 in its downward position.

In an aspect, bridge 124 and sidewalls 132 of guide structure 126 can move together, e.g., moving bridge 124 moves sidewalls 132 and vice versa. Accordingly, depressing bridge 124 downward along longitudinal axis 8 can depress sidewalls 132 downward in a longitudinal direction generally parallel to longitudinal axis 8. In an aspect, gaps 301 of CPA member 300 (FIG. 1B) can receive sidewalls 132 that are depressed downward. Gaps 301 receiving sidewalls 132 can support limiting the size of the electrical connector in a longitudinal direction.

Further advancing female housing 100 and CPA member 300 with respect to male housing 200 can cause center beam 316 of CPA member 300 to deflect based on its interaction with bridge 124 and lock arm 222 (FIG. 10). As bridge 124 is depressed downward along longitudinal axis 8, bridge 124 can apply a load generally along longitudinal axis 8, which can be generally perpendicular to a transverse axis of center beam 316. This can deflect center beam 316 in a downward direction away from its initial position because leading edge 123 of bridge 124 can be seated in leading edge 330 of deflecting arm 326 such that a portion of center beam 316 extends below flexible bridge 124. Accordingly, lock arm 222 can cause center beam 316 to deflect and initiate advancement of CPA member 300 to final lock position 35 (FIGS. 12-13). In an aspect, center beam 316 of CPA member 300 can deflect in a longitudinal direction generally parallel to longitudinal axis 8.

As shown in FIG. 11, further advancing the male housing 200 with respect to the female housing 100 and CPA member 300 can cause bridge 124 to move out of alignment with deflecting arm 326 of CPA member 300 along transverse axis 6 (FIG. 9A), such that the components are no longer in blocking engagement. As such, bridge 124 can return to its initial position behind lock arm 222 and can generate a “click” sound.

As bridge 124 returns to its initial position, lock arm 222 can continue to deflect deflecting arm 326 such that CPA member 300 can advance generally along a flat plane toward rear 204 of male housing 200 (FIG. 9A) with center beam 316 deflecting away from its undeformed state along the flat plane. In some aspects, as bridge 124 returns to its initial position, sidewalls 132 of guide structure 126 can move to the initial position such that they are no longer within gaps 301 of CPA member 300 (FIG. 1B). This is because bridge 124 and sidewalls 132 can move together, e.g., moving bridge 124 moves sidewalls 132 and vice versa.

Center beam 316 can deflect downward within center beam groove 120. Accordingly, in some aspects, at least part of the movement of CPA member 300 can be contained within female housing 100. In an aspect, inclined edge 322 of bottom surface 320 of center beam 316 can be inclined to allow deflection within center beam groove 120. In an aspect, deflection can cause engagement between inclined edge 322 and center beam groove 120. Because of its incline, inclined edge 322 can be received by center beam groove 120 and center beam 316 can sufficiently deflect within female housing 100 to advance CPA member 300 to final lock position 35 (FIGS. 12-13).

In some aspects, center beam 316 of CPA member 300 can provide tactile and/or auditory feedback while the female housing 100 and CPA member 300 assembly and male housing 200 are coupled into fully mated position 30 (FIGS. 12-13).

As shown in FIG. 11, continuing to advance the female housing 100 and CPA member 300 assembly can cause lock arm 222 of male housing 200 and bridge 124 to move out of alignment. Bridge 124 can move upwards to its initial position, where it can once again abut and engage with lock arm 222 of male housing 200. As bridge returns to its initial position, its leading edge 123 can abut and engage with trailing edge 221 of lock arm 222. Trailing edge 221 of lock arm 222 can be flat and generally parallel to longitudinal axis 8 (FIG. 10) such that bridge 124 can return to its initial position behind lock arm 222 without any resistance in the longitudinal direction once it clears leading edge 224 and bottom edge 225 of lock arm 222. Leading edge 123 of bridge 124 can also include a flat portion that can engage with flat trailing edge 221 of lock arm 222. In this way, leading edge 123 of bridge 124 can glide along trailing edge 221 of lock arm to easily return to its initial position. In its initial position, bridge 124 can be aligned with lock arm 222 of male housing 200 along transverse axis 6 (FIG. 9A). Bridge 124 can contact an interior surface of top 210 of male housing 200 when returning to its initial position, which can create a tactile and/or audible feedback signal (e.g., a click sound). The cleared path to its initial position supported by trailing edge 221 of lock arm 222 can provide momentum to bridge 124 to return to its initial position such that a “click” sound is generated upon contact with the interior surface of top 210 of male housing 200. In this position, bridge 124 does not abut and/or engage with deflecting arm 326 of CPA member 300.

As bridge 124 returns to its initial, undeformed position, deflecting arm 326 of CPA member 300 can abut and engage lock arm 222 of male housing 200. Accordingly, deflecting arm 326 of CPA member 300 and lock arm 222 of male housing 200 can remain in transverse alignment along transverse axis 6 (FIG. 9A).

In some aspects, CPA member 300 can be advanced toward male housing 200 and can cause deflecting arm 326 of CPA member 300 to move past leading edge 224 of lock arm 222 of male housing 200 and bridge 124, as shown in FIGS. 11 and 12. In some aspects, deflecting arm 326 can be generally flat between trailing edge 328 and leading edge 330 to engage leading edge 224 of lock arm 222 of male housing 200 and bridge 124. Bottom edge 225 of lock arm 222 can be flat to engage deflecting arm 326 of CPA member 300 and deflect center beam 316 downward. In some aspects, flat bottom edge 225 of lock arm 222 can engage deflecting arm 326 along its flat edge between trailing edge 328 and leading edge 330 such that the two flat edges glide along each other. In some aspects, bridge 124, can be generally flat between its leading edge 123 and trailing edge 125 such that flat edge of deflecting arm 326 can glide along bridge 124. With reference to FIGS. 11-12, CPA member 300 can continue to advance toward rear 204 of male housing 200 until its deflecting arm 326 can once again abut and engage with bridge 124, but on the opposite surface of bridge 124.

As shown in FIG. 12, unlike in pre-lock position 15 and pre-mate position 10, in final lock position 35 and fully mated position 30, trailing edge 328 can abut and engage with bridge 124. In final lock position 35, trailing edge 328 of deflecting arm 326 can abut and engage with trailing edge 125 of bridge 124. In some aspects, trailing edge 125 of bridge 124 can be curved and/or inclined to be seated with inclined trailing edge 328 of deflecting arm 326. In this position, deflecting arm 326 of CPA member 300 can be aligned with bridge 124 along transverse axis 6 (FIG. 9A). Once deflecting arm 326 of CPA member 300 reaches the fully coupled position, the electrical connector can be in fully mated position 30 (FIG. 13).

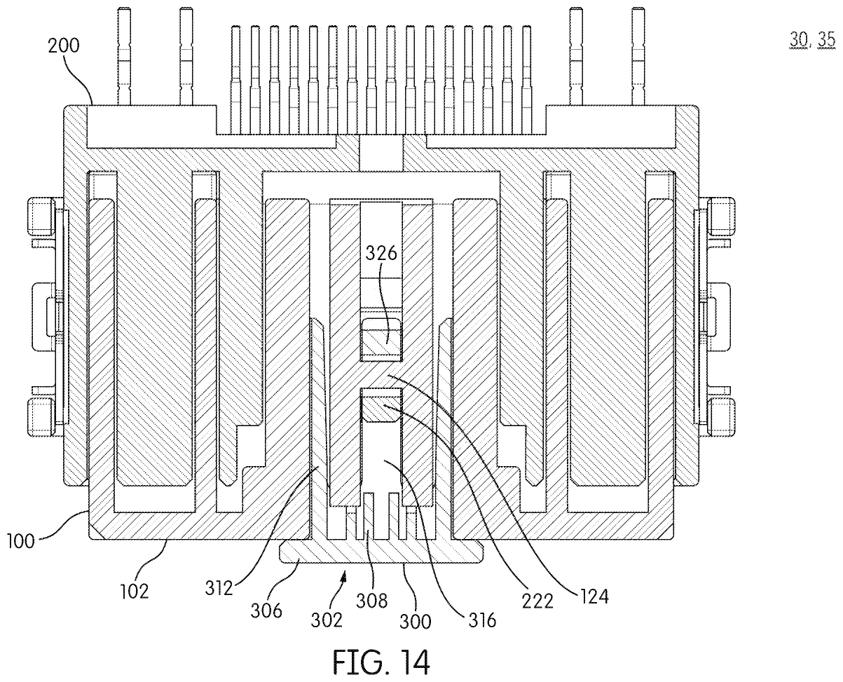

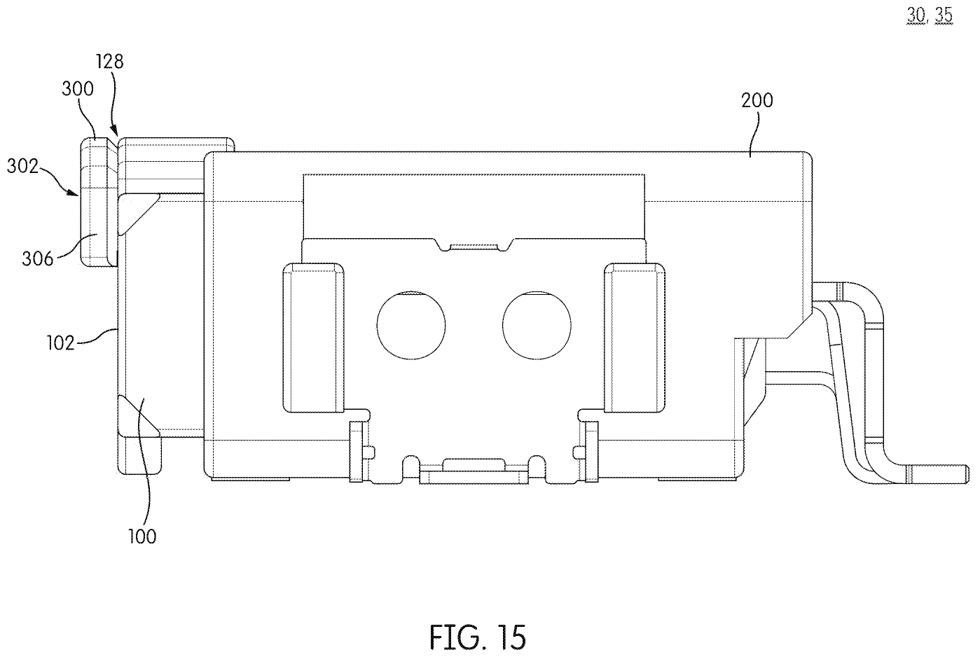

As shown in FIGS. 13-15, in final lock position 35 and fully mated position 30, front wall 306 of CPA member 300 can abut front 102 of female housing 100. This can provide visual feedback that CPA member 300 is in final lock position 35 and the electrical connector is in fully mated position 30, because front wall 306 of CPA member 300 is proximate to front 102 of female housing 100.

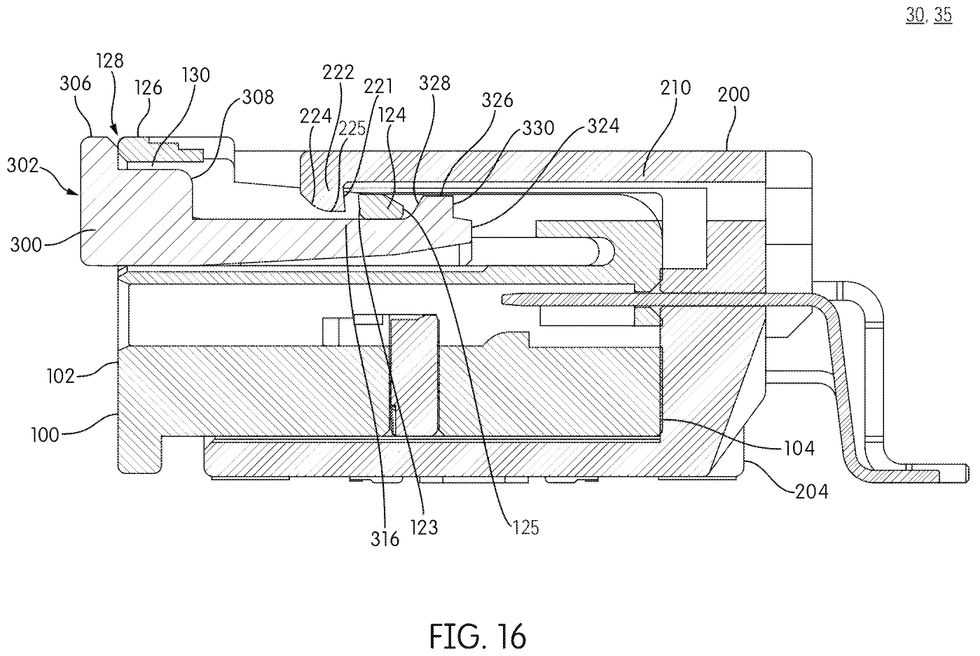

As shown in FIGS. 13 and 16, contact between rear 204 of male housing 200 and rear 104 of female housing 100 can prevent the components from advancing further. Additionally, similar to bridge 124, in final lock position 35 and fully mated position 30, deflecting arm 326 of CPA member 300 can abut and engage with top 210 of male housing 200. In some aspects, deflecting arm 326 can contact an interior surface of top 210 of male housing 200. In some aspects, the contact between deflecting arm 326 and an interior surface of top 210 of male housing 200 when center beam 316 of CPA member 300 returns to its initial position can create a tactile and/or audible feedback signal (e.g., a click sound) signaling that the electrical connector is in final lock position 35 and the connector housings are coupled with position assurance in fully mated position 30.

In some aspects, lock arm 222 of male housing 200 can be disposed within female housing 100 between bridge 124 and guide structure 126, e.g., in an aperture between bridge 124 and guide structure 126. Additionally in final lock position 35 and fully mated position 30, CPA member 300 can abut and engage with upper wall 130 of guide structure 126 such that the gap existing in pre-lock position 15 and pre-mate position 10 (FIGS. 4-5) between CPA member 300 and upper wall 130 is closed. In some aspects, medial walls 308 of CPA member 300 can abut and engage with upper wall 130. In some aspects, interference between CPA member 300 and upper wall 130 of guide structure 126 can prevent deflection of center beam 316. Accordingly, CPA member 300 can resist deflection to initiate decoupling of female housing 100 and male housing 200. Overcoming this resistance can be difficult in order to prevent accidental decoupling, but can be done intentionally to provide maintenance to the electrical connector, for example. CPA member 300 can be released and then female housing 100 and male housing 200 can be decoupled.

In an aspect, the interference between CPA member 300 and upper wall 130 of guide structure 126 can prevent bridge 124 and sidewalls 132 from being depressed downwardly in a longitudinal direction generally parallel to longitudinal axis 11 (FIG. 5). Because front wall 306 of CPA member 300 can abut front 102 of female housing 100, sidewalls 132 can be prevented from being depressed into gaps 301 of CPA member 300 (FIG. 1B). Instead, sidewalls 132 can contact CPA member 300, which can resist downward depression of sidewalls 132. Additionally, the interference between CPA member 300 and upper wall 130 of guide structure 126 can prevent long-term downward deformation of CPA member 300 and bridge 124 in a longitudinal direction generally parallel to longitudinal axis 11. Accordingly, CPA member 300 and bridge 124 can maintain a strong bias toward its undeflected state. This can additionally prevent accidental decoupling of female housing 100 and male housing 200 from fully mated position 30.

The present invention(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

What is claimed is:

1. A connector, comprising:
a male housing having a downwardly extending arm;
a female housing having a bridge to engage the downwardly extending arm; and
a connector position assurance member having an upwardly extending deflecting arm, the deflecting arm having an edge to abut the bridge.

2. The connector of claim 1, wherein the female housing comprises an aperture to receive the downwardly extending arm.

3. The connector of claim 1, wherein the downwardly extending arm, bridge, and deflecting arm are generally aligned along a transverse axis.

4. The connector of claim 3, wherein the downwardly extending arm and the bridge abut a top of the male housing.

5. The connector of claim 1, wherein during coupling, the bridge is elastically deformed downward from its initial position.

6. The connector of claim 5, wherein downwardly extending arm is rigid to drive the bridge downward from the initial position during coupling.

7. The connector of claim 6, wherein prior to coupling, the bridge is seated in an edge of the connector position assurance member to engage the connector position assurance member and move the connector position assurance member downward during coupling.

8. The connector of claim 7, wherein after coupling, the bridge returns to the initial position.

9. The connector of claim 5, wherein during coupling, the downwardly extending arm and the deflecting arm are aligned in a longitudinal direction.

10. An assembly for a connector, the assembly comprising:
a housing having a guide structure and a bridge, the guide structure having an aperture; and
a connector position assurance member having a center beam disposed in the aperture and an arm to engage with the bridge.

11. The assembly of claim 10, wherein the center beam is cantilevered.

12. The assembly of claim 10, wherein the bridge is depressed to deflect the center beam when the assembly is coupled to a male housing.

13. The assembly of claim 10, wherein the guide structure engages with the connector position assurance member to prevent deflection of the center beam.

14. The assembly of claim 10, wherein the arm comprises a flat top surface to engage the bridge.

15. The assembly of claim 10, wherein the arm abuts a first side and a second side of the bridge.

16. The assembly of claim 10, wherein the bridge is positioned in a curved edge of the arm to block the arm from advancing toward a rear of the housing.

17. The assembly of claim 10, wherein the bridge is positioned in an inclined edge of the arm to retain the arm in the housing.

18. A connector position assurance member, comprising:
a front wall at a first height;
a medial wall extending perpendicularly from the front wall at a second height lower than the first height;
a lateral beam at a third height lower than the second height; and
a center beam adjacent to the lateral beam.

19. The connector position assurance member of claim 18, wherein the center beam comprises an inclined bottom surface.

20. The connector position assurance member of claim 18, wherein the lateral beam comprises one or more outwardly extending protrusions to engage one or more surfaces of a housing.
